(19) United States
(12) Patent Application Publication
(10) Pub. No.: US 2014/0166716 A1
(43) Pub. Date: Jun. 19, 2014

(54) SPLITTING APPARATUS

(71) Applicants: Tai-Cheng Tsai, Tainan City (TW); Yung-Tsung Lin, Tainan City (TW); Gwo-Jiun Sheu, Tainan City (TW); Shou-Wen Hsu, Tainan City (TW)

(72) Inventors: Tai-Cheng Tsai, Tainan City (TW); Yung-Tsung Lin, Tainan City (TW); Gwo-Jiun Sheu, Tainan City (TW); Shou-Wen Hsu, Tainan City (TW)

(73) Assignee: GENESIS PHOTONICS INC., Tainan City (TW)

(21) Appl. No.: 13/917,626

(22) Filed: Jun. 13, 2013

(30) Foreign Application Priority Data
Dec. 19, 2012 (TW) 1011484423

(51) Int. Cl. B28D 5/00

(52) U.S. Cl. CPC B28D 5/0023
USPC 225/103

(57) ABSTRACT

A splitting apparatus suitable to split a work piece along at least one cutting line formed on the work piece is provided. The splitting apparatus includes a chopper, a detector, a controller and an adjustor. The chopper is disposed above the work piece. The detector is disposed above the work piece for transmitting a signal to the work piece so as to get a specification data of the work piece. The controller connects the detector and receives the specification data and generates an adjustment data. The adjustor connects the controller and the chopper. The adjustor receives the adjustment data and adjusts a parameter data of the chopper according to the adjustment data so that the chopper splits the work piece for once along the cutting line formed on the work piece.

### CROSS-REFERENCE TO RELATED APPLICATION

This application claims the priority benefit of Taiwan application serial no. 101148423, filed on Dec. 19, 2012. The entirety of the above-mentioned patent application is hereby incorporated by reference herein and made a part of this specification.

### BACKGROUND OF THE INVENTION

1. Field of the Invention

The present invention generally relates to a splitting apparatus, in particular, to a splitting apparatus suitable for splitting a wafer.

2. Description of Related Art

In the process of fabricating LED chips, each of a plurality of chip regions in a wafer is separated to form a plurality of independent LED chips by performing a splitting process after the laser cutting the lateral cutting lines and the vertical cutting lines. In the conventional art, the splitting apparatus is mostly to use for performing splitting process. The wafer to be splitting is disposed in a predetermined position below the wafer splitting apparatus and then the chopper is driven down at the predetermined height, so the actuator supplies a force to the chopper, and the chopper impacts the predetermined position of the wafer to split the wafer.

The thicknesses of the wafers are slight inconsistency after the thinning process before cutting. Hence, after the laser cutting, the depth and the width of the cutting lines formed on the wafers will be inconsistent due to the inconsistent thicknesses of the wafers. However, the splitting apparatus supplies the same splitting force in each of the cutting lines, and the splitting apparatus fails to split the wafer for once so that the splitting process is needed to perform once more. In addition, even though the image sensor is disposed on the splitting apparatus, only whether the wafer is split can be obtained and to decide whether or not the splitting process needs to perform once more. Namely, the splitting apparatus can not be instantly informed the situation of the work piece. Furthermore, after performing the splitting process once more, the situation, such as the discontinuous cutting surface, burrs or peeling, etc., may be generated on the cutting face of the wafer, especially when the chopper is not in an acute shape, so as to cause the cutting surface of the wafer to crack and result in damages. Therefore, how to effectively avoid the splitting process performed once more has become one of the most important issues at the design of the splitting apparatus.

### SUMMARY OF THE INVENTION

The invention is directed to a splitting apparatus having a detector to get the situation of a work piece instantaneously.

In an embodiment of the invention, a splitting apparatus suitable for splitting a work piece along at least one cutting line formed on the work piece is provided. The splitting apparatus includes a chopper, a detector, a controller and an adjustor. The chopper is disposed above the work piece. The detector is disposed above the work piece for transmitting a signal to the work piece so as to get a specification data of the work piece. The controller connects the detector and receives the specification data, and generates an adjustment data. The adjustor connects the controller and the chopper, wherein the adjustor receives the adjustment data and adjusts a parameter data of the chopper according to the adjustment data so that the chopper splits the work piece for once along the cutting line formed on the work piece.

According to an embodiment of the invention, the detector includes an acoustic wave detector or a light wave detector.

According to an embodiment of the invention, the signal includes an acoustic wave signal or a light wave signal.

According to an embodiment of the invention, the specification data includes a depth and a width of the cutting line.

According to an embodiment of the invention, the controller includes a computer.

According to an embodiment of the invention, the adjuster comprises an actuator.

According to an embodiment of the invention, the parameter data includes a splitting velocity and a splitting force of the chopper.

According to an embodiment of the invention, the adjustment data includes a depth and a width of the cutting line by way of mathematics.

According to an embodiment of the invention, the work piece includes a thinned wafer.

According to an embodiment of the invention, the splitting apparatus further includes an image sensor, wherein the image sensor is disposed beside the detector for capturing patterns of the work piece.

Based on the above, the splitting apparatus described in the embodiments of the invention includes the detector, and the signal transmitted by the detector allows the user to instantaneously get the specification data of the work piece, i.e. the depth and the width of the cutting line. Hence, before the chopper splitting, the situation of the cutting lines can be instantly informed, so that the received specification data can be calculated by the controller to generate the adjustment data, and the adjustor can adjust the parameter data of the chopper according to the adjustment data. Therefore, the splitting apparatus described in the embodiments of the invention can avoid the splitting process to perform once more, and a splitting yield can be improved.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of a splitting apparatus according to an embodiment of the invention.

FIG. 1B is a schematic view of a work piece according to an embodiment of the invention.

FIG. 2 is a schematic view of a splitting apparatus according to another embodiment of the invention.

### DESCRIPTION OF THE EMBODIMENTS

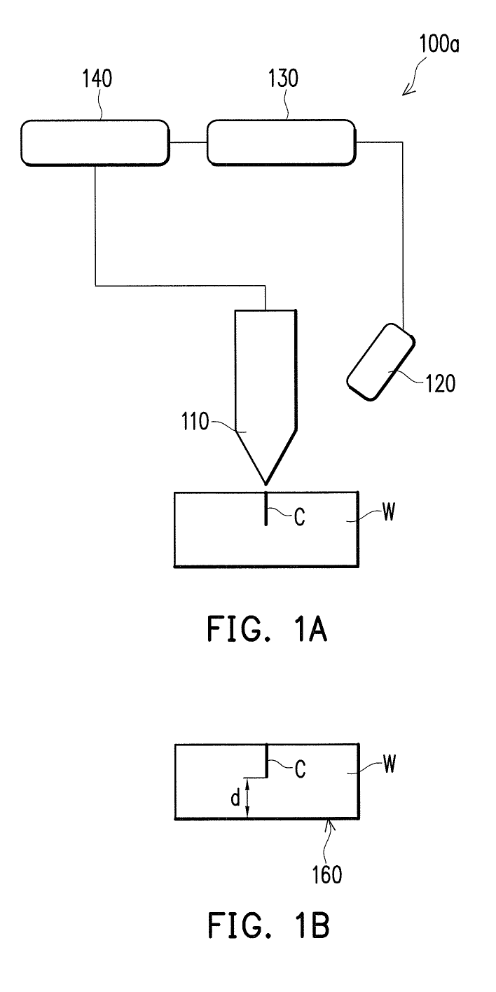

FIG. 1A is a schematic view of a splitting apparatus according to an embodiment of the invention. With reference to FIG. 1A, according to the present embodiment, the splitting apparatus 100a suitable for splitting a work piece W along at least one cutting line C formed on the work piece W is provided, wherein the work piece W is, for example, a thinned wafer. The splitting apparatus 100a includes a chopper 110, a detector 120, a controller 130 and an adjustor 140. The chopper 110 is disposed above the work piece W. The detector 120 is disposed above the work piece W for transmitting a signal to the work piece W so as to get a specification data of the work piece W, wherein the specification data includes a depth and a width of the cutting line C. The controller 130 connects the detector 120 and receives the specification data, and generates an adjustment data. The adjustor 140 connects the controller 130 and the chopper 110, wherein the adjustor 140 receives the adjustment data and adjusts a parameter data of the chopper 110 according to the adjustment data so that the chopper 110 splits the work piece W for once along the cutting line C formed on the work piece W.

More specifically, the detector 120 of the present embodiment is, for example, an acoustic wave detector or a light wave detector. In other words, in case when the detector 120 is the acoustic wave detector, the signal transmitted by the detector 120 is an acoustic wave signal. Namely, the specification data of the cutting line C can be got via the acoustic wave. On the other hand, in case when the detector 120 is the light wave detector, the signal transmitted by the detector 120 is a light wave signal. Namely, the specification data of the cutting line C can be got via the light wave. Furthermore, the controller 130 is, for example, a computer which may calculate the specification data by way of mathematics and generate the adjusting information, wherein the adjustment data includes a depth and a width of the cutting line by way of mathematics. In addition, the adjuster 160 of the present embodiment is, for example, an actuator which may adjust the parameter data of the chopper 110 according to the adjustment data, wherein the parameter data is, for example, a splitting velocity and a splitting force of the chopper 110. Hence, the chopper 110 can split the work piece W for once.

Since the splitting apparatus 100a described in the present embodiment includes the detector 120, and the signal transmitted by the detector 120 allows the user to instantaneously get the specification data of the work piece W, i.e. the depth and the width of the cutting line C. Hence, before the chopper 110 spitting, the situation of the cutting lines C can be instantly informed, so that the received specification data can be calculated by the controller 130 to generate the adjustment data, and the adjustor 140 can adjust the parameter data of the chopper 110 according to the adjustment data. Therefore, the splitting apparatus 100a described in the present embodiment can avoid the splitting process to perform once more, and a splitting yield can be improved.

It should be noted that the specification data got from the signal transmitted by the detector 120 of the splitting apparatus 100a in the present embodiment can be a relative depth d of the work piece W, as shown in FIG. 1B. Herein, the relative depth d is substantially a distance between an end of the cutting line C adjacent to a lower surface 160 of the work piece W and the lower surface 160 of the work piece W. Therefore, the received specification data can be calculated by the controller 130 to generate the adjustment data, and the adjustor 140 can adjust the parameter data of the chopper 110 according to the adjustment data. Therefore, the splitting process performed once more can be avoided, and a splitting yield can be improved.

It should be noted that, the embodiments described hereafter employ the reference labels and a portion of the technical content in the afore-described embodiment, and same or similar reference labels are used to represent the same or the like elements. Moreover, description of the same technical content is omitted. The omitted portion of the description can be referred to the afore-described embodiment, and therefore is not repeated herein.

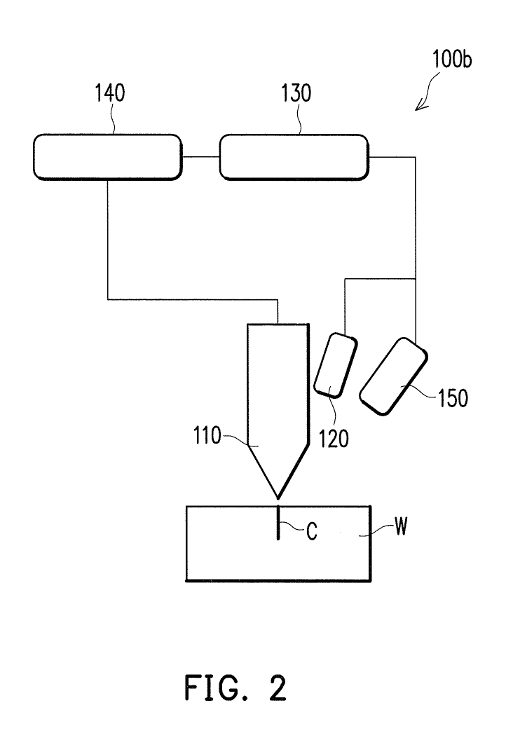

FIG. 2 is a schematic view of a splitting apparatus according to another embodiment of the invention. With reference to FIG. 2, a splitting apparatus 100b of the present embodiment is similar to the splitting apparatus 100a in FIG. 1A, while the main difference therebetween lies in that the splitting apparatus 100a described in the present embodiment further includes an image sensor 150, wherein the image sensor 150 is dispose beside the detector 120 for capturing patterns of the work piece W so as to determine the situation of the work piece W and ensure that the work piece W has been split up into independent units, such as a plurality of independent LED chip.

In light of the foregoing, the splitting apparatus described in the embodiments of the invention includes the detector, and the signal transmitted by the detector allows the user to instantaneously get the specification data of the work piece, i.e. the depth and the width of the cutting line. Hence, before the chopper splitting, the situation of the cutting lines can be instantly informed, so that the received specification data can be calculated by the controller to generate the adjustment data, and the adjustor can adjust the parameter data of the chopper according to the adjustment data. Therefore, the splitting apparatus described in the embodiments of the invention can avoid the splitting process to perform once more, and a splitting yield can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A splitting apparatus suitable for splitting a work piece along at least one cutting line formed on the work piece, the splitting apparatus comprising:
a chopper disposed above the work piece;
a detector disposed above the work piece for transmitting a signal to the work piece so as to get a specification data of the work piece;
a controller connecting the detector and receiving the specification data, and generating an adjustment data; and
an adjustor connecting the controller and the chopper, wherein the adjustor receives the adjustment data and adjusts a parameter data of the chopper according to the adjustment data so that the chopper splits the work piece for once along the cutting line formed on the work piece.

2. The splitting apparatus as recited in claim 1, wherein the detector comprises an acoustic wave detector or a light wave detector.

3. The splitting apparatus as recited in claim 2, wherein the signal comprises an acoustic wave signal or a light wave signal.

4. The splitting apparatus as recited in claim 1, wherein the specification data comprises a depth and a width of the cutting line.

5. The splitting apparatus as recited in claim 1, wherein the controller comprises a computer.

6. The splitting apparatus as recited in claim 1, wherein the adjuster comprises an actuator.

7. The splitting apparatus as recited in claim 1, wherein the parameter data comprises a splitting velocity and a splitting force of the chopper.

8. The splitting apparatus as recited in claim 1, wherein the adjustment data comprises a depth and a width of the cutting line by way of mathematics.

9. The splitting apparatus as recited in claim 1, wherein the work piece comprises a thinned wafer.

10. The splitting apparatus as recited in claim 1, further comprising:
an image sensor disposed beside the detector for capturing patterns of the work piece.
